(19) United States
(12) Patent Application Publication
(10) Pub. No.: US 2026/0249408 A1
(43) Pub. Date: Aug. 27, 2026

(54) CLAMPING SYSTEM

(71) Applicant: SK On Co., Ltd., Seoul (KR)

(72) Inventors: Cheol Ho JUNG, Daejeon (KR); Sung Woon JUNG, Daejeon (KR)

(21) Appl. No.: 19/543,862

(22) Filed: Feb. 19, 2026

(30) Foreign Application Priority Data
Feb. 21, 2025 (KR) 10-2025-0022972
Sep. 16, 2025 (KR) 10-2025-0132789

(51) Int. Cl. B23Q 3/06; B23Q 3/08

(52) U.S. Cl. CPC B23Q 3/065; B23Q 3/088

(57) ABSTRACT

A clamping system includes: a membrane structure including a first end secured to an object and a second end opposite to the first end; and a clamp configured to clamp the membrane structure such that tension is applied between the first end and the second end. The clamp includes: a first gripping portion including a suction hole, and a support surface positioned closer to the object than the suction hole; and a second gripping portion including a protrusion projecting toward the support surface. At least one of the first gripping portion and the second gripping portion is movable to adjust a gap between the protrusion and the support surface.

### CROSS-REFERENCE TO RELATED PATENT APPLICATION

The present application claims priority under 35 U.S.C. § 119(a) to Korean patent application number 10-2025-0022972 filed on February 21, 2025, and Korean patent application number 10-2025-0132789 filed on September 16, 2025 in the Ministry of Intellectual Property, the entire disclosure of which is incorporated by reference herein.

### BACKGROUND OF THE INVENTION

### 1. Field

The present disclosure relates to a clamping system.

### 2. Description of the Related Art

An electrode assembly includes a cathode, an anode, and a separator interposed between the cathode and the anode. The electrode assembly may be used to manufacture a battery cell. To manufacture a battery cell using the electrode assembly, an outer circumferential surface of the electrode assembly may be wrapped by an insulating membrane structure (e.g., a separator). Thus, unwanted electrical short circuits due to contact between the electrode assembly being wrapped by the membrane structure and other components included in the battery cell (e.g., the case) may be prevented from occurring.

For the aforementioned wrapping, a clamping system including a clamp for clamping the membrane structure may be used. In such a case, if the clamp fails to clamp the membrane structure, a problem may occur in completely wrapping the electrode assembly with the membrane structure.

### SUMMARY OF THE INVENTION

An aspect of the present disclosure is to provide a clamping system that can determine whether a membrane structure has unintentionally disengaged from a clamp.

The present disclosure may be widely applied to electric vehicles, battery charging stations, and energy storage systems (ESS), as well as to other green technologies, such as photovoltaics and wind power. In addition, the present disclosure may be used for eco-friendly mobility intended to suppress air pollution and greenhouse gas emissions to prevent climate change, including electric and hybrid vehicles.

According to embodiments of the present disclosure, a clamping system includes a membrane structure including a first end secured to an object and a second end opposite to the first end; and a clamp configured to clamp the membrane structure such that tension is applied between the first end and the second end. The clamp may include: a first gripping portion including a suction hole, and a support surface positioned closer to the object than the suction hole; and a second gripping portion including a protrusion projecting toward the support surface. At least one of the first gripping portion and the second gripping portion may be moveable to adjust a gap between the protrusion and the support surface.

According to an embodiment, the clamping system may further include a control unit configured to determine a clamping state of the membrane structure by the clamp during a clamping interval from a clamping start time to a clamping end time. The clamping start time may be a time at which the membrane structure is clamped between the protrusion and the support surface as the gap is set to a first gap. The clamping end point may be a point at which the gap is set to a gap greater than the first gap.

According to an embodiment, at the clamping start time, the membrane structure may block the suction hole, and a first pressure lower than atmospheric pressure may be formed inside the suction hole blocked by the membrane structure.

According to an embodiment, the clamping state may include a first clamping state in which the suction hole is blocked by the membrane structure. At a time between the clamping start time and the clamping end time, the control unit may be configured to determine whether the claiming state is the first clamping state by comparing a pressure inside the suction hole with the first pressure.

According to an embodiment, the clamping state may further include a second clamping state in which the suction hole is in communication with an exterior. At a time between the clamping start time and the clamping end time, the control unit may be configured to determine that the clamping state is the second clamping state when a pressure inside the suction hole is higher than the first pressure.

According to an embodiment, the control unit may generate a first warning signal when the clamping state is determined to be the second clamping state.

According to an embodiment, the first gripping portion may further include an additional suction hole. The additional suction hole may be spaced apart from the suction hole by the support surface.

According to an embodiment, at the clamping start time, the membrane structure may further block the additional suction hole, and a second pressure lower than atmospheric pressure may be formed inside the additional suction hole blocked by the membrane structure.

According to an embodiment, the clamping state may further include a third clamping state in which both the suction hole and the additional suction hole are in communication with an exterior. At a time between the clamping start time and the clamping end time, the control unit may be configured to determine the clamping state to be the third clamping state when a pressure inside the suction hole is higher than the first pressure and a pressure inside the additional suction hole is higher than the second pressure.

According to an embodiment, each of the suction hole and the additional suction hole may have a plurality of holes along a direction perpendicular to a direction from the suction hole toward the additional suction hole.

According to an embodiment, the protrusion may be shaped to extend along the first direction.

According to an embodiment, the protrusion may be shaped to have a cross-sectional area that decreases along the direction toward the support surface.

According to an embodiment, the protrusion may include a material having lower rigidity than the support surface.

According to an embodiment, the object may include an electrode assembly including a cathode, an anode, and a separator interposed between the cathode and anode.

According to an embodiment, the membrane structure may include the same material as the separator.

According to an embodiment of the present disclosure, a clamping system capable of determining whether a membrane structure has been unintentionally disengaged from a clamp.

### BRIEF DESCRIPTION OF THE DRAWINGS

FIG. 1 is a schematic drawing illustrating a clamping system according to embodiments of the present disclosure.

FIG. 2 is a schematic drawing illustrating one embodiment of the object of FIG. 1.

FIG. 3 is a schematic drawing illustrating one embodiment of the clamp of FIG. 1.

FIG. 4 is a schematic drawing illustrating another embodiment of the clamp of FIG. 1.

FIGS. 5 and 6 are schematic drawings illustrating a winding process using the clamping system of FIG. 1.

FIGS. 7 and 8 are schematic drawings illustrating a pre-clamping state prior to the clamping interval.

FIGS. 9 and 10 are drawings illustrating a first clamping state that may be present during a clamping interval.

FIGS. 11 and 12 are drawings illustrating a second clamping state that may be present during the clamping interval.

FIGS. 13 and 14 are drawings illustrating a third clamping state that may be present during the clamping interval.

FIG. 15 is a schematic control flowchart illustrating the operation of a clamping system during a clamping interval.

### DETAILED DESCRIPTION

Hereinafter, the present disclosure will be described in detail with reference to the accompanying drawings. However, these are exemplary only and the present disclosure is not limited to the specific embodiments illustrated.

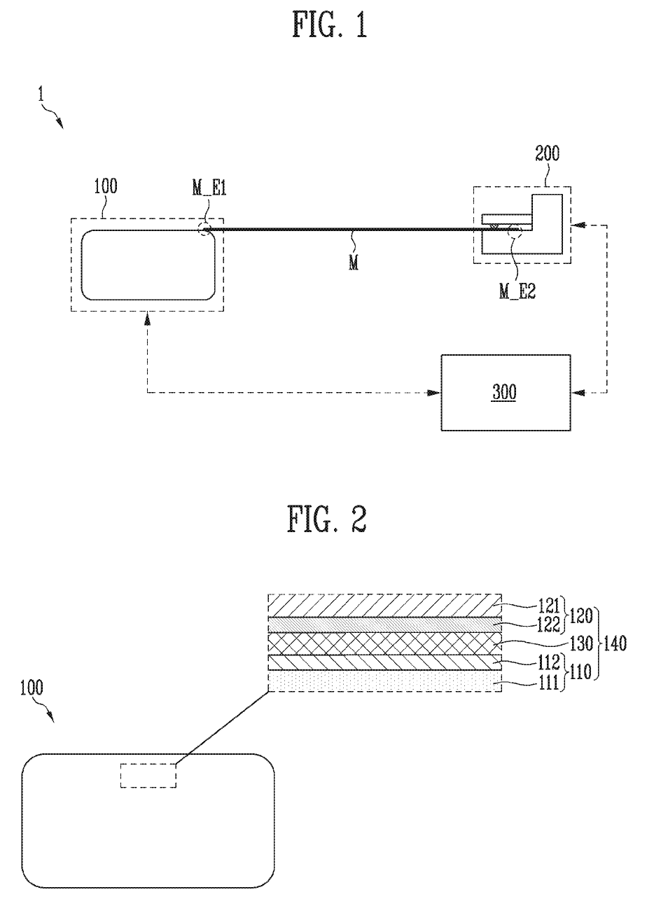

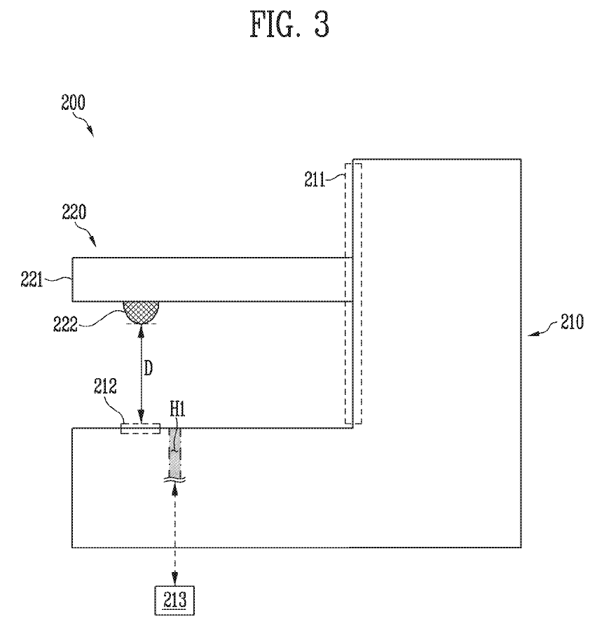

FIG. 1 is a schematic drawing illustrating a clamping system according to embodiments of the present disclosure. FIG. 2 is a schematic drawing illustrating one embodiment of the object of FIG. 1. FIG. 3 is a schematic drawing illustrating one embodiment of the clamp of FIG. 1.

Referring to FIGS. 1 to 3, a clamping system 1 according to embodiments of the present disclosure may include: a membrane structure M including a first end M_E1 secured to an object 100 and a second end M_E2 opposite to the first end (M_E1); and a clamp 200 configured to clamp the membrane structure M such that a tension is applied between the first end M_E1 and the second end M_E2.

According to an embodiment, the object 100 may include an electrode assembly 140 having a cathode 110, an anode 120, and a separator 130 interposed between the cathode 110 and the anode 120. The electrode assembly 140 can convert chemical energy into electrical energy (or electrical energy into chemical energy). The electrode assembly 140 can be used to manufacture a battery cell. A battery cell with the electrode assembly 140 can be used as a power source for various devices (e.g., electronic devices, electric vehicles, and/or energy storage).

According to an embodiment, the electrode assembly 140 may have a wound structure with a cathode 110, anode 120, and separator 130 wound thereon. However, the present disclosure is not limited to this structure. For example, the electrode assembly 140 may have a stacking shape, a zigzag-folding shape, or a stack-folding shape.

According to an embodiment, the cathode 110 may include a cathode current collector 111 and a cathode active material layer 112 coated (or formed) on at least one side of the cathode current collector 111. According to an embodiment, the anode 120 may include an anode current collector 121 and an anode active material layer 122 coated (or formed) on at least one side of the anode current collector 121. According to an embodiment, the separator 130 may be interposed between the cathode active material layer 112 (or, the cathode current collector 111) and the anode active material layer 122 (or, the anode current collector 121), and may serve to prevent unintended electrical short circuits between the cathode 110 and anode 120.

According to an embodiment, the clamp 200 may include a first gripping portion 210 and a second gripping portion 220. The first gripping portion 210 may include a suction hole H1, and a support surface 212 positioned closer to the object 100 than the suction hole H1. The second gripping portion 220 may include a protrusion 222 that projects toward the support surface 212.

According to an embodiment, at least one of the first gripping portion 210 and the second gripping portion 220 may be movable to adjust a gap D between the protrusion 222 and the support surface 212. For example, the first gripping portion 210 may include a lifting surface 211. The second gripping portion 220 may include a lifting portion 221 that is movable along the lifting surface 211 in a direction toward or away from the support surface 212. In this case, the protrusion 222 may be configured to project from one side of the lifting portion 221 toward the support surface 212.

However, the present disclosure is not limited to the above. For example, instead of the second gripping portion 220, the first gripping portion 210 may be configured to be movable. In another example, both the first gripping portion 210 and the second gripping portion 220 may be configured to be movable. According to an embodiment, the clamp 200 may be configured as a pincer-like clamp, in which case the first gripping portion 210 may include a first resilient member (e.g., a spring) configured to urge the first gripping portion 210 such that the support surface 212 faces the protrusion 222, and the second gripping portion 220 may include a second resilient member (e.g., a spring) configured to urge the second gripping portion 220 such that the protrusion 222 faces the support surface 212. The first resilient member and the second resilient member may be formed as a single body or may be provided separately. As such, the clamp 200 of the present disclosure may, without limitation, have various structures that can effectively secure a object to be clamped (e.g., a membrane structure M) between the support surface 212 and the protrusion 222.

In the aforementioned embodiments, the movement of the first gripping portion 210 and/or the second gripping portion 220 may be controlled by a control unit 300 included in the clamping system 1 . The control unit 300 may be configured to control various operations of the clamping system 1 (or various operations of components included in the clamping system 1).

According to an embodiment, the suction hole H1 may be configured to draw in air. For example, the suction hole H1 may be provided with a first suction control unit 213 that controls the suction hole H1 to draw in air. For example, the first suction control unit 213 may comprise a device (e.g., a suction motor) for the air suction. According to an embodiment, the first suction control unit 213 may further comprise a pressure measuring unit for measuring the pressure inside the suction hole H1. The first suction control unit 213 may be controlled, for example, by the control unit 300.

According to an embodiment, as shown in FIG. 3, the first suction control unit 213 may be provided as a component separate from the first gripping portion 210 and the second gripping portion 220. However, the present disclosure is not limited thereto. For example, the first suction control unit 213 may be configured to be included in the first gripping portion 210 (or, alternatively, the second gripping portion 220). For example, one component of the first suction control unit 213 (e.g., a pressure measuring unit) may be configured to be included in the first gripping portion 210 (or the second gripping portion 220), and another component of the first suction control unit 213 (e.g., a suction motor) may be provided as a component separate from the first gripping portion 210 (or the second gripping portion 220).

According to an embodiment, when the object 100 includes the electrode assembly 140, the membrane structure M may include the same material as the separator 130. In such cases, the clamping system 1 may be used to wrap the membrane structure M around the outer circumferential surface of the electrode assembly 140. The electrode assembly 140 may include components that are prone to electrical short circuits, such as the cathode 110 and anode 120. By wrapping the outer circumferential surface of the electrode assembly 140 with the membrane structure M, the cathode 110 (or, alternatively, the anode 120) disposed at the outer circumferential surface of the electrode assembly 140 may be prevented from contact with other components (e.g., a case of a battery cell), thereby preventing unwanted electrical short circuits.

As such, the clamping system 1 may be used to perform a winding process for wrapping the outer circumferential surface of the object 100 with the membrane structure M. In this case, for a tight wrapping, it is necessary to apply an appropriate (or sufficient) tension between the first end M_E1 of the membrane structure M secured to the object 100 and the second end M_E2 of the membrane structure M opposite to the first end M_E1. In such a case, there is a risk that the tension applied to the membrane structure M during the winding process may cause the membrane structure M clamped by the clamp 200 to be disengaged. Therefore, it is necessary to ensure that the clamping of the membrane structure M by the clamp 200 is reliable.

According to an embodiment, the protrusion 222 may be shaped to have a cross-sectional area that decreases along a direction toward the support surface 212. For example, as shown in FIG. 3, the protrusion 222 may have a semicircular (or, semi-elliptical) shape. Accordingly, a contact area between the protrusion 222 and a portion of the membrane structure M clamped between the protrusion 222 and the support surface 212 may be minimized, thereby preventing damage to the membrane structure M. In addition, the holding force applied by the clamp 200 to the membrane structure M may be improved. Furthermore, in a state where the membrane structure M is clamped between the protrusion 222 and the support surface 212, the suction hole H1 (and the additional suction hole H2) may not be blocked by the protrusion 222, thereby improving the reliability in determining the clamping state ST by the control unit 300 (to be described later).

According to an embodiment, the protrusion 222 may include a material having lower rigidity than the support surface 212. For example, the support surface 212 may be formed of a material having relatively high rigidity (e.g., metal and/or plastic), and the protrusion 222 may be formed of a material having relatively low rigidity (e.g., a polymer). Accordingly, damage to a portion of the membrane structure M that may be pressed against the protrusion 222 and clamped between the protrusion 222 and the support surface 212 may be prevented.

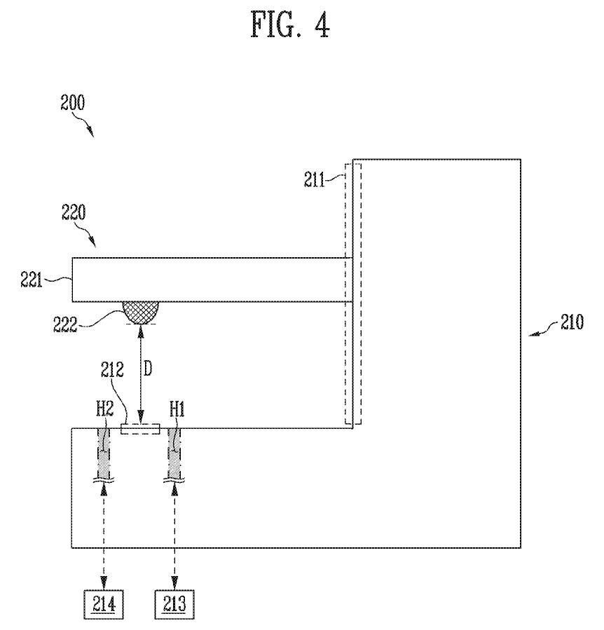

FIG. 4 is a schematic drawing to illustrate another embodiment of the clamp of FIG. 1 .

Hereinafter, the description will focus on the differences from the embodiment described with reference to FIG. 3, and repetitive descriptions will be avoided.

Referring to FIG. 4, according to an embodiment, the first gripping portion 210 may further include an additional suction hole H2. The additional suction hole H2 may be spaced apart from the suction hole H1 with the support surface 212 interposed therebetween.

According to an embodiment, the additional suction hole H2 may be configured to draw in air. For example, the additional suction hole H2 may be provided with a second suction control unit 214 that controls the additional suction hole H2 to draw in air. For example, the second suction control unit 214 may include a device (e.g., a suction motor) for suctioning air. According to an embodiment, the second suction control unit 214 may further include a pressure measuring unit for measuring the pressure inside the additional suction hole H2. The second suction control unit 214 may be controlled, for example, by the control unit 300.

According to an embodiment, as shown in FIG. 4, the second suction control unit 214 may be provided as a component separate from the first gripping portion 210 and the second gripping portion 220. However, the present disclosure is not limited thereto. For example, the second suction control unit 214 may be configured to be included in the first gripping portion 210 (or, alternatively, the second grip portion 220). For example, one component of the second suction control unit 214 (e.g., a pressure measuring unit) may be configured to be included in the first gripping portion 210 (or the second gripping portion 220), and another component of the second suction control unit 214 (e.g., a suction motor) may be provided as a component separate from the first gripping portion 210 (or the second gripping portion 220).

According to an embodiment, as shown in FIG. 4, the second suction control unit 214 may be provided as a component provided separately from the first suction control unit 213. However, the present disclosure is not limited thereto. For example, the second suction control unit 214 and the first suction control unit 213 may share at least one component (e.g., the suction motor).

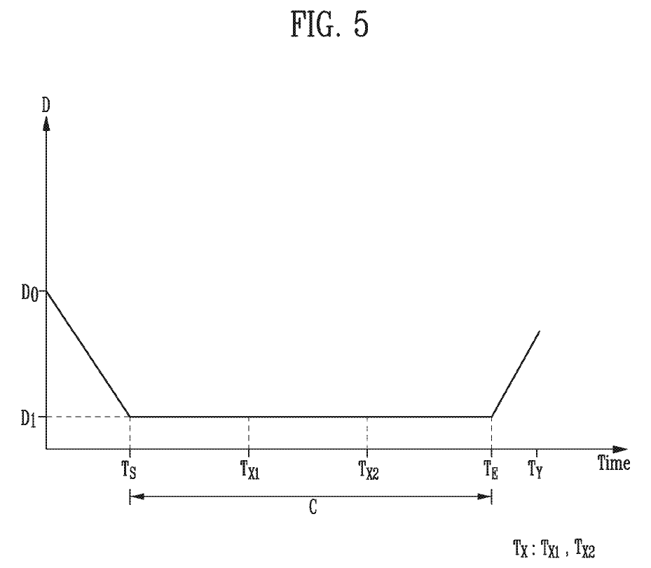

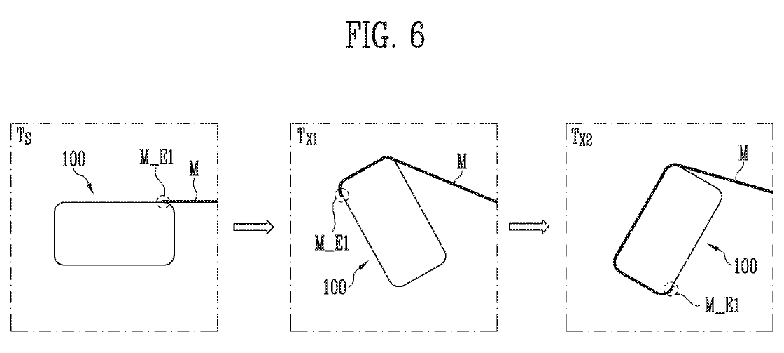

FIGS. 5 and 6 are schematic drawings to illustrate a winding process using the clamping system of FIG. 1.

Referring to FIG. 5, the winding process may include a clamping interval C from a clamping start time T_{S} to a clamping end time T_{E}.

The clamping start time T_{S} may be a time at which the membrane structure M is clamped between the protrusion 222 and the support surface 212 as a gap D between the protrusion 222 and the support surface 212 is set to a first gap D₁. For example, the clamping start time T_{S} may be a time at which the gap D between the protrusion 222 and the support surface 212 decreases from an initial gap D₀ to become the first gap D₁.The first gap D₁ may be substantially equal to the thickness of the membrane structure M. For example, the first gap D₁ may be about 95% to about 100% of the thickness of the membrane structure M, but the present disclosure is not limited thereto. The first gap D₁ may be set to a gap at which the membrane structure M can be effectively secured between the protrusion 222 and the support surface 212.

The clamping end time T_{E} may be a time at which the outer circumferential surface of the object 100 has been completely enclosed by the membrane structure M. After the clamping end time T_{E}, the membrane structure M clamped by the clamp 200 may be disengaged. That is, the clamping end time T_{E} may be a time at which the gap D between the protrusion 222 and the support surface 212 is set to be greater than the first gap D₁. For example, from the clamping end time T_{E} to a post-clamping time T_{Y}, the gap D between the protrusion 222 and the support surface 212 may increase from the first gap D1.

As described above, the clamping of the membrane structure M by the clamp 200 needs to be maintained during the clamping interval C (i.e., during the winding process). Thus, the gap D between the protrusion 222 and the support surface 212 may be maintained substantially at the first gap D₁during the clamping interval C.

According to an embodiment, an arbitrary time point T_{X} during the clamping interval C may be defined. For example, the time point T_{X} may be any time point after the clamping start time T_{S} and before the clamping end time T_{E}. According to an embodiment, the time point T_{X} may include a first time point T_{X1} and a second time point T_{X2} occurring after the first time point T_{X1}.

Referring to FIG. 6, a winding process during the clamping interval C is schematically illustrated. During the clamping interval C, the membrane structure M may be clamped by the clamp 200 such that tension is applied between the first end M_E1 and the second end M_E2.

At the clamping start time T_{S}, the membrane structure M may not yet substantially wrap the outer circumferential surface of the object 100.

During the interval from the clamping start time T_{S} to the first time point T_{X1}, the object 100 may rotate along a preset rotation direction. Accordingly, at the first time point T_{X1}, the membrane structure M may be wrapped around a portion of the outer circumferential surface of the object 100.

During the interval from the first time point T_{X1} to the second time point T_{X2}, the object 100 may further rotate along the rotation direction. Accordingly, at the second time point T_{X2}, the membrane structure M may be further wrapped around not only the first portion of the outer circumferential surface of the object 100, but also another portion of the outer circumferential surface of the object 100.

As such, during the clamping interval C, the rotation of the object 100 may cause the membrane structure M to wrap around the entire outer circumferential surface of the object 100. In such a case, there is a risk that the membrane structure M clamped by the clamp 200 may be d disengaged due to the tension applied to the membrane structure M during the clamping interval C. Therefore, it is necessary to ensure that the clamping of the membrane structure M by the clamp 200 is reliable.

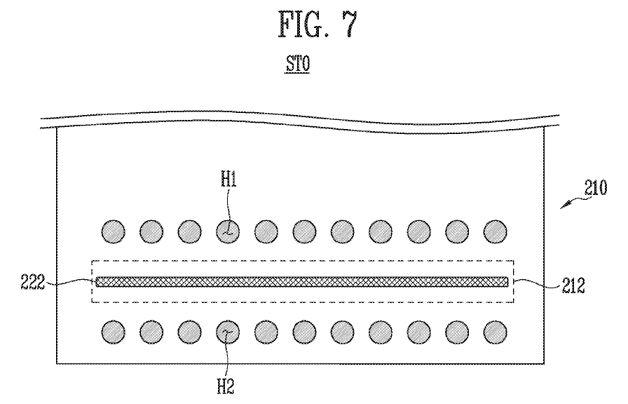

According to an embodiment, the control unit 300 may determine the clamping status ST of the membrane structure M clamped by the clamp 200 during the clamping interval C from the clamping start time T_{S} to the clamping end time T_{E}. In other words, during the clamping interval C, the control unit 300 may be configured to monitor the reliability of the clamping of the membrane structure M clamped by the clamp 200. In this regard, detailed descriptions will be made below with reference to FIGS. 7 to 15.

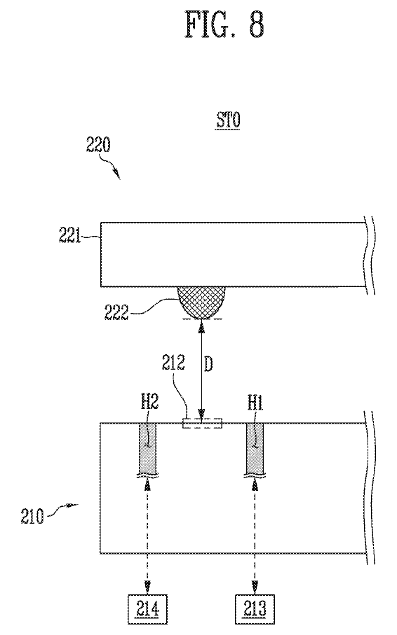

FIGS. 7 and 8 are schematic drawings to illustrate a pre-clamping state before the clamping interval.

Referring to FIGS. 7 and 8, the pre-clamping state ST0 may be a state before the membrane structure M is clamped by the clamp 200. For example, the pre-clamping state ST0 may correspond to a time point before the clamping start time T_{S}.

According to an embodiment, in the pre-clamping state ST0, the gap D between the protrusion 222 and the support surface 212 may be greater than the first gap D₁. According to an embodiment, in the pre-clamping state ST0, each of the first suction control unit 213 and the second suction control unit 214 may be inoperative. For example, in the pre-clamping state ST0, each of the suction hole H1 and the additional suction hole H2 may not draw in air.

According to an embodiment, as shown in FIG. 7, each of the suction hole H1 and the additional suction hole H2 may have a plurality of holes along a direction perpendicular to the direction from the suction hole H1 toward the additional suction hole H2. In such a case, according to an embodiment, the protrusion 222 may be shaped to extend along that direction. As such, the protrusion 222, the suction holes H1, and the additional suction holes H2 may be configured to prevent interference with each other at the positions described above.

In the embodiments described above, the first suction control unit 213 may control the suction pressures of the plurality of suction holes H1 to be substantially equal. In this way, if there is no substantial deviation among the suction pressures of the plurality of suction holes H1 controlled by the first suction control unit 213, damage to the outer appearance of the membrane structure M caused by differences in suction pressure can be prevented.

In the aforementioned embodiment, the second suction control unit 214 may control the suction pressures of the plurality of additional suction holes H2 to be substantially equal. In this way, if there is no substantial deviation among the suction pressures of the plurality of additional suction holes H2 controlled by the second suction control unit 214, damage to the outer appearance of the membrane structure M caused by differences in suction pressure can be prevented.

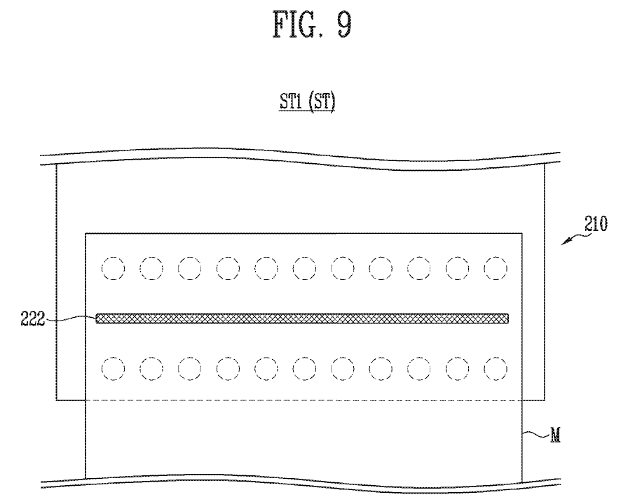

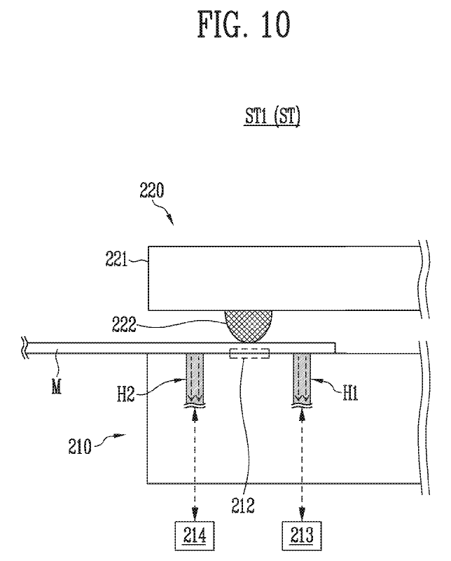

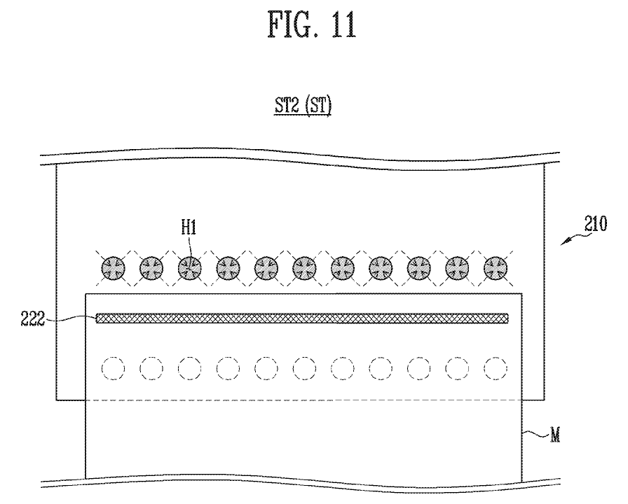

FIGS. 9 and 10 are drawings for illustrating a first clamping state that may be present during a clamping interval.

Referring to FIGS. 9 and 10, the clamping state ST may include a first clamping state ST1, in which the suction hole H1 is blocked by the membrane structure M.

According to an embodiment, in the first clamping state ST1, the membrane structure M may block the suction hole H1. In this case, a first pressure lower than atmospheric pressure may be formed inside the suction hole H1 blocked by the membrane structure M. For example, in the first clamping state ST1, the first suction control unit 213 may be operated, and accordingly, a negative pressure (e.g., the first pressure) may be formed inside the suction hole H1 blocked by the membrane structure M. In the first clamping state ST1, the first pressure formed inside the suction hole H1 may be measured by a pressure measuring unit included in the first suction control unit 213. According to an embodiment, the pressure measuring unit included in the first suction control unit 213 may transmit information corresponding to the measured first pressure to the control unit 300.

According to an embodiment, at the clamping start time T_{S}, the membrane structure M may further block the additional suction hole H2. In this case, a second pressure lower than atmospheric pressure may be formed inside the additional suction hole H2 blocked by the membrane structure M. For example, in the first clamping state ST1, the second suction control unit 214 may be operated, and accordingly, a negative pressure (e.g., the second pressure) may be formed inside the additional suction hole H2 blocked by the membrane structure M. In the first clamping state ST1, the second pressure formed inside the additional suction hole H2 may be measured by a pressure measuring unit included in the second suction control unit 214. According to an embodiment, the pressure measuring unit included in the second suction control part 214 may transmit information corresponding to the measured second pressure to the control unit 300.

According to an embodiment, the clamping state ST at the clamping start time T_{S} maybe the first clamping state ST1. For example, at the clamping start time T_{S}, the membrane structure M may cover the suction hole H1, and the first pressure may be formed inside the suction hole H1 covered by the membrane structure M. For example, at the clamping start time T_{S}, the membrane structure M may cover the additional suction hole H2, and the second pressure may be formed inside the additional suction hole H2 covered by the membrane structure M.

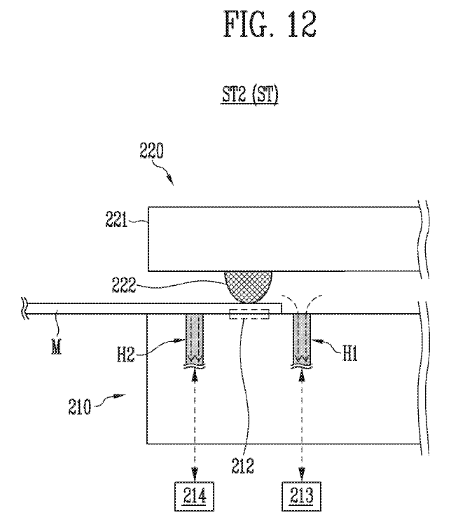

FIGS. 11 and 12 are drawings for illustrating a second clamping state that may be present during the clamping interval.

Referring to FIGS. 11 and 12, the clamping state ST may include a second clamping state ST2 in which the suction hole H1 is in communication with the exterior.

According to an embodiment, the second clamping state ST2 may be a state that occurs as the membrane structure M, which was in the first clamping state ST1, is pulled by tension and changes its position. For example, the second clamping state ST2 may occur at any time T_{X} during the clamping interval C between the clamping start time T_{S} and the clamping end time T_{E}.

According to an embodiment, in the second clamping state ST2, as in the first clamping state ST1, the membrane structure M may be clamped between the protrusion 222 and the support surface 212. The second clamping state ST2 may be, for example, a state immediately before the membrane structure M disengages from the protrusion 222 and the support surface 212 due to tension applied to the membrane structure M (or a state in which there is a high risk of such disengagement).

In the second clamping state ST2, the suction hole H1 may be in communication with the exterior. Accordingly, even if the first suction control unit 213 is operating, the pressure inside the suction hole H1 may increase as external air flows into the suction hole H1. This increase in pressure inside the suction hole H1 may be measured, for example, by a pressure measuring unit included in the first suction control unit 213. According to an embodiment, the pressure measurement unit included in the first suction control unit 213 may transmit information corresponding to the measured increase in pressure inside the suction hole H1 to the control unit 300.

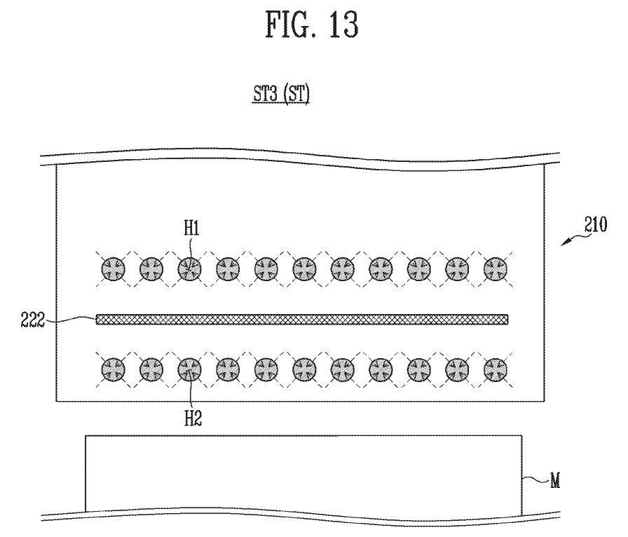

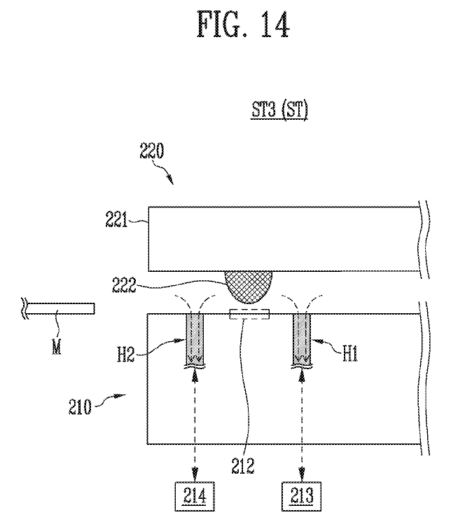

FIGS. 13 and 14 are drawings for illustrating a third clamping state that may be present during the clamping interval.

Referring to FIGS. 13 and 14, the clamping state ST may include a third clamping state ST3 in which both the suction hole H1 and the additional suction hole H2 are in communication with the exterior.

According to an embodiment, the third clamping state ST3 may be a state that occurs as the membrane structure M, which was in the second clamping state ST2, is further pulled by tension and changes its position. For example, the third clamping state ST3 may occur at any time T_{X} during the clamping interval C between the clamping start time T_{S} and the clamping end time T_{E}.

According to an embodiment, in the third clamping state ST3, the membrane structure M may be completely disengaged from the protrusion 222 and the support surface 212. As a result, the suction hole H1 and the additional suction hole H2 may be in communication with the exterior.

In such a case, even if the first suction control unit 213 and the second suction control unit 214 are operating, the pressure inside the suction hole H1 and the additional suction hole H2 may increase as external air flows into the suction hole H1 and the additional suction hole H2. Such increases in pressure inside the suction hole H1 and the additional suction hole H2 may be measured, for example, by the pressure measuring unit included in the first suction control unit 213 and the pressure measuring unit included in the second suction control section 214. According to an embodiment, the pressure measuring unit included in the first suction control section 213 and the pressure measuring unit included in the second suction control section 214 may transmit information corresponding to the pressure increases inside the suction hole H1 and the additional suction hole H2 to the control section 300.

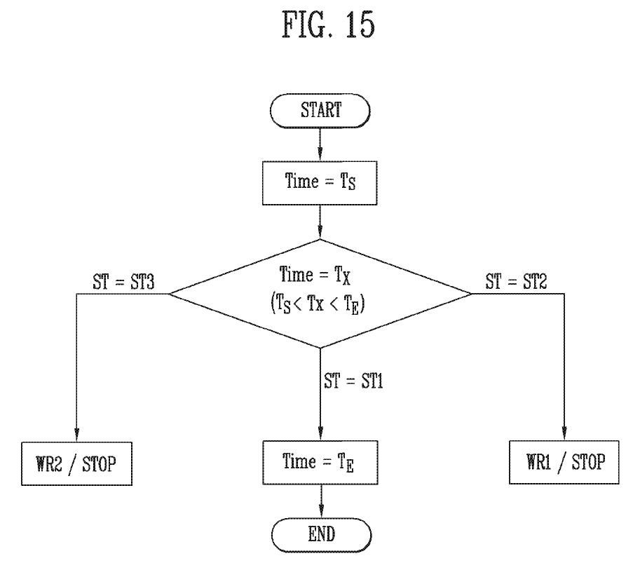

FIG. 15 is a schematic control flowchart illustrating the operation of a clamping system during a clamping interval.

Referring to FIG. 15, according to an embodiment, at a time point T_{X} between the clamping start time T_{S} and the clamping end time T_{E}, the control unit 300 may determine whether the clamping state ST is the first clamping state ST1 by comparing the pressure inside the suction hole H1 with the first pressure. For example, in the first clamping state ST1, the control unit 300 may receive information corresponding to the first pressure from the pressure measurement unit included in the first suction control unit 213. Based on the received information, the control unit 300 may determine that the clamping state ST is the first clamping state ST1.

When the control unit 300 determines that the clamping state ST is the first clamping state ST1 at all time points T_{X} during the clamping interval C between the clamping start time T_{S} and the clamping end time T_{E}, the winding process described with reference to FIGS. 5 and 6 may be continuously performed without interruption. Thus, according to the clamping system 1 of the present disclosure, it is possible to monitor in real time whether the clamping state ST is maintained in the first clamping state ST1 as a normal state during the clamping interval C.

According to an embodiment, at a time point T_{X} between the clamping start time T_{S} and the clamping end time T_{E}, the control unit 300 may be configured to determine that the clamping state ST is the second clamping state ST2 when the pressure inside the suction hole H1 becomes higher than the first pressure. For example, in the second clamping state ST2, the control unit 300 may receive information corresponding to an increase in the pressure inside the suction hole H1 from the pressure measuring unit included in the first suction control unit 213. Based on the received information, the control unit 300 may determine whether the clamping state ST is the second clamping state ST2.

According to an embodiment, the control unit 300 may generate a first warning signal WR1 when the clamping state ST is determined to be the second clamping state ST2. The second clamping state ST2 may be, as described above, a state immediately before the membrane structure M disengages from the protrusion 222 and the support surface 212 (or a state in which a risk of separation is high), and thus the clamping system 1 may be configured to determine whether to stop the operation based on the first warning signal WR1. For example, when the first warning signal WR1 is generated, the control unit 300 may stop the operation of the clamping system 1 based on the first warning signal WR1.

According to an embodiment, at a time point T_{X} between a clamping start time T_{S} and a clamping end time T_{E}, the control unit 300 may be configured to determine that the clamping state ST is the third clamping state ST3 when the pressure inside the suction hole H1 is higher than the first pressure and the pressure inside the additional suction hole H2 is higher than the second pressure. For example, in the third clamping state ST3, the control unit 300 may receive information corresponding to an increase in the pressure inside the suction hole H1 and an increase in the pressure inside the additional suction hole H2 from the pressure measuring unit included in the first suction control unit 213 and the pressure measuring unit included in the second suction control unit 214. Based on the received information, the control unit 300 may determine whether the clamping state ST is the third clamping state ST3.

According to an embodiment, the control unit 300 may generate a second warning signal WR2 when the clamping state ST is determined to be the third clamping state ST3. The third clamping state ST3 may be a state in which the membrane structure M is completely disengaged from the protrusion 222 and the support surface 212, as described above, and the clamping system 1 may be configured to immediately stop the operation based on the second warning signal WR2. For example, when the second warning signal WR2 is generated, the control unit 300 may immediately stop the operation of the clamping system 1 based on the second warning signal WR2.

Accordingly, the clamping system 1 according to the present disclosure monitors the clamping state ST to determine in real time a state in which the membrane structure M is at high risk of disengagement (or a state in which the membrane structure M is disengaged). Thus, the reliability of clamping the membrane structure M by the clamp 200 can be ensured.

The present disclosure may be embodied in various forms, and the scope of the present disclosure is not limited to the aforementioned embodiments. Therefore, any modified embodiment that includes the elements of the appended claims shall fall within the scope of the present disclosure.

What is claimed is:

1. A clamping system comprising: a membrane structure comprising a first end secured to an object and a second end opposite to the first end; and a clamp configured to clamp the membrane structure such that tension is applied between the first end and the second end, wherein the clamp comprises: a first gripping portion comprising a suction hole, and a support surface positioned closer to the object than the suction hole; and a second gripping portion comprising a protrusion projecting toward the support surface, and at least one of the first gripping portion and the second gripping portion is movable to adjust a gap between the protrusion and the support surface.

2. The clamping system of claim 1, further comprising a control unit configured to determine a clamping state of the membrane structure by the clamp during a clamping interval from a clamping start time to a clamping end time, wherein the clamping start time is a time at which the membrane structure is clamped between the protrusion and the support surface as the gap is set to a first gap, and wherein the clamping end time is a time at which the gap is set to a gap greater than the first gap.

3. The clamping system of claim 2, wherein, at the clamping start time, the membrane structure blocks the suction hole, and a first pressure lower than atmospheric pressure is formed inside the suction hole blocked by the membrane structure.

4. The clamping system of claim 3, wherein the clamping state comprises a first clamping state in which the suction hole is blocked by the membrane structure, and at a time between the clamping start time and the clamping end time, the control unit is configured to determine whether the claiming state is the first clamping state by comparing a pressure inside the suction hole with the first pressure.

5. The clamping system of claim 4, wherein the clamping state further comprises a second clamping state in which the suction hole is in communication with an exterior, and at a time between the clamping start time and the clamping end time, the control unit is configured to determine that the clamping state is the second clamping state upon a pressure inside the suction hole being higher than the first pressure.

6. The clamping system of claim 5, wherein the control unit generates a first warning signal upon determining the clamping state to be the second clamping state.

7. The clamping system of claim 4, wherein the first gripping portion further comprises an additional suction hole, and the additional suction hole is spaced apart from the suction hole with the support surface interposed therebetween.

8. The clamping system of claim 7, wherein, at the clamping start time, the membrane structure further blocks the additional suction hole, and a second pressure lower than atmospheric pressure is formed inside the additional suction hole blocked by the membrane structure.

9. The clamping system of claim 8, wherein, the clamping state further comprises a third clamping state in which both the suction hole and the additional suction hole are in communication with an exterior, and at a time between the clamping start time and the clamping end time, the control unit is configured to determine that the clamping state is the third clamping state upon a pressure inside the suction hole being higher than the first pressure and a pressure inside the additional suction hole being higher than the second pressure.

10. The clamping system of claim 7, wherein each of the suction hole and the additional suction hole comprises a plurality of holes along a direction perpendicular to a direction from the suction hole toward the additional suction hole.

11. The clamping system of claim 10, wherein the protrusion is shaped to extend along the direction.

12. The clamping system of claim 1, wherein the protrusion is shaped to have a cross-sectional area that decreases along the direction toward the support surface.

13. The clamping system of claim 1, wherein the protrusion comprises a material having lower rigidity than the support surface.

14. The clamping system of claim 1, wherein, the object comprises an electrode assembly comprising a cathode, an anode, and a separator interposed between the cathode and the anode.

15. The clamping system of claim 14, wherein the membrane structure comprises the same material as the separator.
